(19) United States
(12) Patent Application Publication
(10) Pub. No.: US 2017/0305789 A1
(43) Pub. Date: Oct. 26, 2017

(54) GLASS AND CHEMICALLY STRENGTHENED GLASS

(71) Applicant: ASAHI GLASS COMPANY, LIMITED, Chiyoda-ku (JP)

(72) Inventors: Naoki FUJII, Tokyo (JP); Shusaku AKIBA, Tokyo (JP)

(73) Assignee: ASAHI GLASS COMPANY, LIMITED, Chiyoda-ku (JP)

(21) Appl. No.: 15/631,589

(22) Filed: Jun. 23, 2017

Related U.S. Application Data
(63) Continuation of application No. PCT/JP2015/085711, filed on Dec. 21, 2015.

(30) Foreign Application Priority Data
Dec. 26, 2014 (JP) 2014-266098

(51) Int. Cl. C03C 21/00; C03C 3/093; C03C 3/087; C03C 4/18; C03C 3/085

(52) U.S. Cl. CPC C03C 21/002; C03C 4/18; C03C 3/085; C03C 3/087; C03C 3/093

(57) ABSTRACT

A glass includes, as represented by mole percentage based on oxides, from 60% to 68% of SiO₂, from 8 to 12% of Al₂O₃, from 12 to 20% of Na₂O, from 0.1 to 6% of K₂O, from 6.4 to 12.5% of MgO, and from 0.001 to 4% of ZrO₂. In the glass, a total content of B₂O₃, P₂O₅, CaO, SrO, and BaO is from 0% to 1%. The glass satisfies 2×Al₂O₃/SiO₂≦0.4 and 0<K₂O/Na₂O≦0.3.

### TECHNICAL FIELD

The present invention relates to a glass and a chemically strengthened glass. Chemical strengthening treatment can be applied to the glass in the present invention. The chemically strengthened glass in the present invention can be used for a cover glass and a touch sensor glass for a touch panel display included in information equipment such as a tablet type terminal, a laptop personal computer, a smart phone, and an electronic book reader, a cover glass for electronic equipment such as a camera, a game machine, and a portable music player, a cover glass for a monitor or the like of a liquid crystal television and a personal computer, a cover glass for a vehicle instrument panel, a cover glass for a solar cell, and a multiple glass used in a window of a building or a house.

### BACKGROUND ART

In recent years, for a display device such as a mobile device, a liquid crystal television, and a touch panel, a cover glass (protective glass) has been used in many cases, in order to protect a display and to improve appearance.

For such a display device, weight reduction and thickness reduction are required for differentiation by the thin type design or for reduction of load for transportation. Therefore, a cover glass to be used for protecting a display is also required to be made thin. However, if the thickness of the cover glass is made thin, the strength is lowered, and thus there has been a problem that the cover glass itself is broken and it is not possible that the cover glass performing the original function to protect the display device, by an impact and the like which occurs by flying and falling of an object in a case of an installed type or by dropping during the use in a case of a portable device.

In order to solve the above problem, improving strength of the cover glass is considered, and as such a method, a method of forming a compressive stress layer in a surface of a glass is commonly known. As the method of forming a compressive stress layer in the surface of a glass, an air quenching strengthening method (physical strengthening method) in which a surface of a glass sheet heated to a temperature near a softening point is rapidly quenched by air cooling or the like and a chemical strengthening method in which an alkali metal ion having a small ion radius (typically Li ion or Na ion) on the surface of a glass sheet is exchanged with an alkali ion having a larger ion radius (typically K ion) by the ion exchange at a temperature which is equal to or lower than the glass transition point are representive.

As described above, the thickness of the cover glass is required to be thin. However, when the air quenching strengthening method is applied to a thin glass sheet having a thickness of less than 2 mm as required as a cover glass, the temperature difference between the surface and the inside tends not to arise, thereby it is difficult to form a compressive stress layer, and it is not possible to obtain the desired property of high strength. Therefore, a cover glass strengthened by the latter chemical strengthening method is generally used.

Here, for a use as described above and the like, generally, an ion exchange treatment for chemical strengthening is performed by immersing a glass containing sodium (Na) in a molten salt. A molten salt of potassium nitrate, a mixture of a molten salt of potassium nitrate and sodium nitrate, or the like is used as the molten salt. In such an ion exchange treatment, the ion exchange between sodium (Na) in a glass and potassium (K) in a molten salt is performed. Therefore, when the ion exchange treatment is repeated while the same molten salt is continuously used, sodium concentration in the molten salt is increased (hereinafter, an increase of the sodium concentration in the molten salt is also referred to as deterioration of the molten salt). Here, a chemically strengthened glass which has been subjected to the ion exchange treatment by using a molten salt (hereinafter, also referred to as a deteriorated salt) having an increased sodium concentration has a problem that a surface compressive stress is low compared to a chemically strengthened glass which has been subjected to the ion exchange treatment by using a molten salt which does not contain sodium or has low sodium concentration, and desired strength characteristics are not obtained. As described above, if the sodium concentration in the molten salt becomes high, the surface compressive stress of a glass which has been chemically strengthened is decreased. Thus, there has been a problem that the sodium concentration in the molten salt is required to be strictly managed so as to cause the surface compressive stress of the chemically strengthened glass not to be lower than a desired value, and the molten salt is required to be often replaced.

Considering such problems, in Patent Literature 1, as a glass composition which is hard to deteriorate a potassium nitrate molten salt, a composition in which the content of MgO is reduced and the content of B₂O₃ is increased is proposed. However, a glass which includes much B₂O₃ has a problem that volatilization of B₂O₃ largely occurs, it is difficult to suppress an occurrence of striae on the glass, and bricks are largely eroded, and thus such a glass is not suitable for mass production.

In Patent Literature 2, a glass composition is proposed which can make a decrease ratio in a surface compressive stress of a chemically strengthened glass due to an increase of sodium concentration in a molten salt to be small, and can maintain high surface compressive stress even if a deteriorated salt is used. However, in the glass composition disclosed in Patent Literature 2, the total amount of SiO₂ and Al₂O₃ is large in any case, and such a glass has a high viscosity value at a high temperature, and foam quality in glass melting is bad. Therefore there is a problem that productivity is not good. Patent Literature 2 discloses that K₂O is a component that increases the ion exchange rate. However, a glass containing K₂O in the glass disclosed in Patent Literature 2 tends to have a high decrease ratio in a surface compressive stress of a chemically strengthened glass due to an increase of the sodium concentration in the molten salt. Accordingly, when the chemical strengthening treatment is performed, it has been difficult to achieve both of obtaining high surface compressive stress by suppressing the decrease ratio of surface compressive stress even if the deteriorated salt is used and a high ion exchange rate.

### CITATION LIST

### Patent Literature

Patent Literature 1: International Publication No. 2014/098111

Patent Literature 2: JP-A-2013-6755

### SUMMARY OF INVENTION

### Technical Problem

Considering the conventional problems, an object of the present invention is to provide a glass which can have a high surface compressive stress through chemical strengthening treatment, can suppress decrease ratio of the surface compressive stress and obtain high surface compressive stress even if the chemical strengthening treatment is performed using a deteriorated salt, has a high ion exchange rate during the chemical strengthening treatment, and is also excellent in productivity of a glass.

### Solution to Problem

A glass according to an aspect of the present invention contains, as represented by mole percentage based on oxides, from 60 to 68% of SiO₂, from 8 to 12% of Al₂O₃, from 12 to 20% of Na₂O, from 0.1 to 6% of K₂O, from 6.4 to 12.5% of MgO, and from 0.001 to 4% of ZrO₂. The total content of B₂O₃, P₂O₅, CaO, SrO, and BaO is from 0 to 1%. The glass satisfies 2×Al₂O₃/SiO₂≦0.4 and 0<K₂O/Na₂≦0.3.

### Advantageous Effects of Invention

The glass can have high surface a compressive stress through chemical strengthening treatment. In the glass, even if the chemical strengthening treatment is performed by using a deteriorated salt, the decrease ratio of the surface compressive stress is suppressed, and thus it is possible to obtain the high surface compressive stress. Accordingly, it is not necessary that sodium concentration in a molten salt is strictly managed, and it is possible to reduce the frequency of replacement of the molten salt. The glass has a high ion exchange rate during the chemical strengthening treatment and also has excellent productivity of a glass.

### BRIEF DESCRIPTION OF DRAWING

FIG. 1 is a semilogarithmic graph illustrating a relationship between the logarithm (horizontal axis) of an average cooling rate, and CS₁ or CS₂/CS₁ (vertical axis) for glasses in Example 9 and Example 16.

### DESCRIPTION OF EMBODIMENTS

Hereinafter, an embodiment of the present invention will be described in detail.

A glass according to an embodiment of the present invention contains, as represented by mole percentage based on oxides, from 60 to 68% of SiO₂, from 8 to 12% of Al₂O₃, from 12 to 20% of Na₂O, from 0.1 to 6% of K₂O, from 6.4 to 12.5% of MgO, and from 0.001 to 4% of ZrO₂, and the total content of B₂O₃, P₂O₅, CaO, SrO, and BaO is from 0% to 1%. The glass satisfies 2×Al₂O₃/SiO₂≦0.4 and 0<K₂O/Na₂O≦0.3. The glass in the embodiment, in which the content of each glass component is in the above range and which satisfies the above range of 2×Al₂O₃/SiO₂ and K₂O/Na₂O, can have a high surface compressive stress through chemical strengthening treatment. In the glass, even if the chemical strengthening treatment is performed by using a deteriorated salt, the decrease ratio of the surface compressive stress is suppressed, and thus it is possible to obtain the high surface compressive stress. The glass has a high ion exchange rate during the chemical strengthening treatment and also has excellent productivity of a glass.

Each component which is contained or may be contained in the glass in the embodiment will be described below. The amount of each component is not particularly limited and is represented by mole percentage based on oxides.

SiO₂ is an essential component that constitutes a network of glass. The content of SiO₂ is equal to or more than 60%, preferably equal to or more than 61%, more preferably equal to or more than 62%, and further preferably equal to or more than 63%. The content of SiO₂ is equal to or less than 68%, preferably equal to or less than 67%, more preferably equal to or less than 66%, and further preferably equal to or less than 65%. When the content of SiO₂ is equal to or more than 60%, it is possible to reduce the decrease ratio in the surface compressive stress of a chemically strengthened glass due to an increase of sodium concentration in a molten salt. If a flaw is formed on the surface of the obtained glass, it is less likely to cause cracking. The weather resistance and the acid resistance are good, and specific gravity is not increased too much. It is less likely to form a devitrified matter, and it is easy to obtain a transparent glass. When the content of SiO₂ is equal to or less than 68%, it is possible to suppress an increase of a temperature T2 at which the viscosity of the glass is 10² dPa·s, and to easily melt or form the glass. In addition, it is possible to obtain a glass having an excellent weather resistance.

Al₂O₃ is a component that improves the ion exchange performance and the weather resistance, and is essential. The content of Al₂O₃ is equal to or more than 8%, preferably equal to or more than 8.3%, and more preferably equal to or more than 8.5%. The content of Al₂O₃ is equal to or less than 12%, preferably equal to or less than 11%, and more preferably equal to or less than 10%. When the content of Al₂O₃ is equal to or more than 8%, it is possible to obtain a desired surface compressive stress and thickness of the compressive stress layer through the ion exchange. In addition, it is possible to obtain a good weather resistance. When the content of Al₂O₃ is equal to or less than 12%, it is possible to suppress an increase of the temperature T2 at which the viscosity of the glass is 10² dPa·s and a temperature T4 at which the viscosity of the glass is 10⁴ dPa·s, and to easily melt or form the glass. In addition, it is possible to obtain a glass having a good weather resistance. It is possible to suppress an increase of a liquid phase temperature of the glass and to suppress or prevent devitrification of the glass.

From a viewpoint of suppressing an increase of the temperature T2 at which the viscosity of the glass is 10² dPa·s and easily melting or forming the glass, the total content of SiO₂ and Al₂O₃ is preferably equal to or less than 80%, more preferably equal to or less than 78%, and further preferably equal to or less than 76%. From a viewpoint of obtaining a stable transparent glass, the total content of SiO₂ and Al₂O₃ is preferably equal to or more than 68%, more preferably equal to or more than 70%, and further preferably equal to or more than 72%. It is preferable that the total content is higher because the coefficient of thermal expansion is easily reduced.

Na₂O is a component that reduces the decrease ratio in the surface compressive stress of the chemically strengthened glass due to an increase of the sodium concentration in the molten salt, forms a surface compressive stress layer through the ion exchange, or improves the melting property of the glass, and is essential. The content of Na₂O is equal to or more than 12%, preferably equal to or more than 13%, more preferably equal to or more than 13.5%, and further preferably equal to or more than 14%. The content of Na₂O is equal to or less than 20%, preferably equal to or less than 19%, more preferably equal to or less than 18%, and further preferably equal to or less than 17%. When the content of Na₂O is equal to or more than 12%, it is possible to form a desired surface compressive stress layer through the ion exchange. In addition, it is possible to suppress an increase of the temperature T2 at which the viscosity of the glass is 10² dPa·s, and to easily melt or form the glass. When the content of Na₂O is equal to or less than 20%, it is possible to obtain a glass in which the weather resistance is good, cracking is less likely to occur, and the coefficient of thermal expansion is suppressed in the glass.

K₂O is a component that increases the ion exchange rate, and is essential. The content of K₂O is equal to or more than 0.1%, preferably equal to or more than 0.5%, more preferably equal to or more than 1%, and further preferably equal to or more than 1.5%. The content of K₂O is equal to or less than 6%, preferably equal to or less than 5%, more preferably equal to or less than 4%, and further preferably equal to or less than 3.5%. When the content of K₂O is equal to or more than 0.1%, it is possible to perform the ion exchange at a high ion exchange rate. When the content of K₂O is equal to or less than 6%, it is possible to reduce the decrease ratio in the surface compressive stress of the chemically strengthened glass due to an increase of the sodium concentration in the molten salt. It is possible to obtain a glass in which the weather resistance is good, cracking is less likely to occur, and the coefficient of thermal expansion is suppressed.

MgO is a component that improves the melting property of the glass, and is essential. The content of MgO is equal to or more than 6.4%, preferably equal to or more than 7%, more preferably equal to or more than 7.5%, and further preferably equal to or more than 8%. The content of MgO is equal to or less than 12.5%, preferably equal to or less than 12%, more preferably equal to or less than 11.5%, and further preferably equal to or less than 11%. When the content of MgO is equal to or more than 6.4%, it is possible to obtain the excellent melting property of the glass and to maintain an elastic modulus of the glass to be high. Further, it is possible to set a glass transition temperature to be high and to reduce the degree of stress relaxation. When the content of MgO is equal to or less than 12.5%, it is possible to reduce the decrease ratio in the surface compressive stress of the chemically strengthened glass due to an increase of the sodium concentration in the molten salt. It is possible to suppress an increase of a liquid phase temperature of the glass and to suppress or prevent devitrification of the glass. Further, it is possible to perform the ion exchange at a high ion exchange rate.

ZrO₂ is a component that increases the surface compressive stress and improves the weather resistance and the acid resistance, and is essential. The content of ZrO₂ is equal to or more than 0.001%, preferably equal to or more than 0.01%, more preferably equal to or more than 0.1%, and further preferably equal to or more than 0.2%. The content of ZrO₂ is equal to or less than 4%, preferably equal to or less than 3.5%, more preferably equal to or less than 3%, and further preferably equal to or less than 2.5%. When the content of ZrO₂ is equal to or more than 0.001%, it is possible to increase the surface compressive stress when the glass is chemically strengthened, and to improve the weather resistance and the acid resistance. When the content of ZrO₂ is equal to or less than 4%, it is possible to reduce the decrease ratio in the surface compressive stress of the chemically strengthened glass due to an increase of the sodium concentration in the molten salt. It is possible to suppress specific gravity of the glass, and to obtain a glass in which cracking is less likely to occur.

B₂O₃ may be contained in order to improve the melting property of the glass at a high temperature or to improve glass strength. However, generally, if B₂O₃ is contained together with an alkaline component such as Na₂O or K₂O, volatilization of B₂O₃ largely occurs and bricks are significantly eroded. Thus, it is preferable that B₂O₃ is substantially not contained, and it is more preferable that B₂O₃ is not contained. Even in a case where B₂O₃ is contained, B₂O₃ is preferably contained in a range of 0.5% or less and more preferably in a range of 0.1% or less. The expression “is substantially not contained” means that it is not contained except the case where it is contained as unavoidable impurities. The meaning is similarly applied to the following descriptions.

P₂O₅ may be contained in order to improve the melting property at a high temperature or to improve glass strength. However, similarly to B₂O₃, generally, if P₂O₅ is contained together with an alkaline component such as Na₂O or K₂O, volatilization of P₂O₅ largely occurs and bricks are significantly eroded. Thus, it is preferable that P₂O₅ is substantially not contained, and it is more preferable that P₂O₅ is not contained. Even in a case where P₂O₅ is contained, P₂O₅ is preferably contained in a range of 0.5% or less and more preferably in a range of 0.1% or less.

From the above viewpoints, in the glass in the embodiment, the total content of B₂O₃ and P₂O₅ is preferably equal to or less than 0.5%, more preferably equal to or less than 0.2%, and further preferably equal to or less than 0.1%. Typically, B₂O₃ and P₂O₅ are substantially not contained. Preferably, B₂O₃ and P₂O₅ are not contained.

CaO may be contained in order to improve the melting property at a high temperature and to make devitrification less likely to occur. However, if the content of CaO is high, the decrease ratio in the surface compressive stress of the chemically strengthened glass due to an increase of the sodium concentration in the molten salt may be increased. The ion exchange rate may be reduced and a resistance against the occurrence of cracking may be reduced. Thus, in a case of containing CaO, the content of CaO is preferably equal to or less than 0.5% and more preferably equal to or less than 0.3%. Typically, CaO is substantially not contained. Preferably, CaO is not contained.

SrO may be contained in order to improve the melting property at a high temperature and to make devitrification less likely to occur. However, when the content of SrO is high, the decrease ratio in the surface compressive stress of the chemically strengthened glass due to an increase of the sodium concentration in the molten salt may be increased. The ion exchange rate may be reduced and the resistance against the occurrence of cracking may be reduced. Thus, in a case of containing SrO, the content of SrO is preferably equal to or less than 0.5% and more preferably equal to or less than 0.3%. Typically, SrO is substantially not contained. Preferably, SrO is not contained.

BaO may be contained in order to improve the melting property at a high temperature and to make devitrification less likely to occur. However, when the content of BaO is high, the decrease ratio in the surface compressive stress of the chemically strengthened glass due to an increase of the sodium concentration in the molten salt may be increased. The ion exchange rate may be reduced and the resistance against the occurrence of cracking may be reduced. Thus, in a case of containing BaO, the content of BaO is preferably equal to or less than 0.5% and more preferably equal to or less than 0.3%. Typically, BaO is substantially not contained. Preferably, BaO is not contained.

In the glass in the embodiment, from a viewpoint of producing a glass which has no stria and has a high ion exchange ability, the total content of B₂O₃, P₂O₅, CaO, SrO, and BaO is set to be equal to or less than 1%. The total content of the above components is preferably equal to or less than 0.7%, and more preferably equal to or less than 0.5%. Typically, the above components are substantially not contained. Preferably, the above components are not contained.

In the glass in the embodiment, each amount of SiO₂ and Al₂O₃ is adjusted so as to set 2×Al₂O₃/SiO₂(Al³⁺/Si⁴⁺ ratio) to be equal to or less than 0.4, preferably equal to or less than 0.35, more preferably equal to or less than 0.33, and further preferably equal to or less than 0.3. For the main network of glass (having a Si—O bond and an Al—O bond) forming an aluminosilicate glass, modified cations such as Na⁺ exist in order to break the Si-O bond, to donate electrons to non-bridging oxygen or donate electrons for tetra-coordination of Al³⁺, and to perform charge compensation. Al³⁺ forms the network of the glass in a state of tetra-coordination. Thus, in a case of considering a local structure, Na⁺ around Si⁴⁺ weakens the network of glass, while reversely, Na⁺ around Al³⁺ strengthens the network of glass. Thus, if the ion exchange of Na⁺ to K⁺ in the glass is performed, strain is easily relaxed and contribution to an occurrence of the compressive stress is difficult around Si⁴⁺. Around Al³⁺, relaxation of strain is difficult and K⁺ contributes to the occurrence of the compressive stress.

On the other hand, in a case where a deteriorated salt is used, not only but also Na⁺ are present in a molten salt. The compressive stress of an ion exchange glass is directed in a direction of relaxing the compressive stress. Therefore, under a situation where the deteriorated salt is used, it is considered that K⁺ is easily settled around Si⁴⁺ which is less likely to contribute the occurrence of stress, and Na⁺ is easily settled around Al⁴⁺. Thus, the high Al³⁺/Si⁴⁺ ratio causes the decrease ratio in the surface compressive stress of the chemically strengthened glass due to an increase of the sodium concentration in the molten salt to be increased. In a viewpoint of reducing the decrease ratio, as the component of the main network, it is considered that it is preferable that Al³⁺/Si⁴⁺ ratio is as small as possible. In a range of the ratio which is equal to or less than 0.4, it is possible to suppress the decrease ratio in the surface compressive stress of the chemically strengthened glass due to an increase the sodium concentration in the molten salt to be small.

In the glass in the embodiment, each amount of K₂O and Na₂O is adjusted so as to satisfy 0<K₂O/Na₂O≦0.3. K₂O/Na₂O is preferably equal to or more than 0.05, more preferably equal to or more than 0.07, and further preferably equal to or more than 0.1. K₂O/Na₂O is preferably equal to or less than 0.28, more preferably equal to or less than 0.25, and further preferably equal to or less than 0.2. It is possible to perform the ion exchange at a high ion exchange rate by setting K₂O/Na₂O to be more than 0. When K₂O/Na₂O is set to be equal to or less than 0.3, it is possible to suppress the decrease ratio in the surface compressive stress of the chemically strengthened glass due to an increase of the sodium concentration in the molten salt to be small. In a case where a glass includes K₂O, it is considered that, in the ion exchange using the deteriorated salt, a Na⁺ ion itself is easily settled at a Na site in the glass and a K⁺ ion itself is easily settled at a K⁺ site in the glass. Therefore, it is important to reduce the K₂O/Na₂O ratio. In a range of the ratio which is equal to or less than 0.3, it is possible to suppress the decrease ratio in the surface compressive stress of the chemically strengthened glass due to an increase of the sodium concentration in the molten salt to be small.

In the glass in the embodiment, the total content of SiO₂, Al₂O₃, MgO, CaO, ZrO₂, Na₂O, and K₂O is preferably 98.5% or more, more preferably equal to or more than 99%, further preferably equal to or more than 99.5%, and particularly preferably equal to or more than 99.7%. In a case where components other than the above components are used much, production of the glass while suppressing an occurrence of striae or volatilization may be difficult, and it may be difficult to produce a colorless transparent glass. Reduction of an ion exchange capacity or reduction of the surface compressive stress may be caused, and thus the object of the present invention may be impaired.

Although the glass in the embodiment is originally formed from the above-described components, other components may be contained in a range without impairing the object of the present invention. In a case where such components are contained, the total content of the components is preferably equal to or less than 5%, more preferably equal to or less than 3%, and particularly preferably equal to or less than 2%. The total content thereof is typically less than 1.5%. Examples of such components will be described below.

Li₂O is a component that easily causes stress relaxation by lowering a strain point and, as a result, to cause a high surface compressive stress layer not to be obtained. When a Li ion is mixed to a KNO₃ molten salt, the molten salt is significantly deteriorated, and it is difficult to continue to repetitively use the same molten salt. In a case where the deteriorated molten salt is used, the surface compressive stress of the obtained glass is significantly lowered. Therefore, in the glass in the embodiment, even if Li₂O is contained, the content of Li₂O is set to be equal to or less than 0.3%. The content of Li₂O is more preferably equal to or less than 0.2%, further preferably equal to or less than 0.1%, and particularly preferably equal to or less than 0.05%. Typically, Li₂O is substantially not contained. Preferably, Li₂O is not contained.

ZnO may be contained in order to improve the melting property at a high temperature of the glass in many cases. However, in this case, the content of ZnO is preferably equal to or less than 1%. In a case where the glass is produced by a float method, the content of ZnO is set to be preferably equal to or less than 0.5%. When the content of ZnO is more than 0.5%, reduction thereof occurs during float forming, and production defects may occur. Typically, ZnO is substantially not contained. Preferably, ZnO is not contained.

TiO₂ coexists with a Fe ion present in the glass. Thus, TiO₂ may degrade a visible light transmittance and color the glass to be brown. Therefore, the content of TiO₂ is preferably equal to or less than 1% if contained. Typically, TiO₂ is substantially not contained. Preferably, TiO₂ is not contained.

SnO₂ may be contained, for example, in order to improve weather resistance. Even in a case, the content of SnO₂ is preferably equal to or less than 3%. The content of SnO₂ is more preferably equal to or less than 2%, further preferably equal to or less than 1%, and particularly preferably equal to or less than 0.5%. Typically, SnO₂ is substantially not contained. Preferably, SnO₂ is not contained.

In a case of producing by a float process, a float surface of a glass sheet may be colored by reduction of Sb₂O₃ and As₂O₃. Thus, even if Sb₂O₃ and As₂O₃ are contained, the content of each of Sb₂O₃ and As₂O₃ is preferably equal to or less than 0.5%. Typically, Sb₂O₃ and As₂O₃ are substantially not contained. Preferably, Sb₂O₃ and As₂O₃ are not contained.

As a refining agent for glass melting, SO₃, a chloride, a fluoride or the like may appropriately be contained. However, in order to increase visibility of a display device such as a touch panel, it is preferable to reduce components having absorption in a visible light region such as Fe₂O₃, NiO, and Cr₂O₃, which may be included as impurities in raw materials, as far as possible. The content of each of the substances is preferably equal to or less than 0.15%, more preferably equal to or less than 0.1%, and particularly preferably equal to or less than 0.05%, as represented by mass percentage.

A producing method of a glass sheet formed of the glass in the embodiment is not particularly limited. For example, the glass sheet is produced in a manner that various raw materials are mixed in proper amounts, the mixture is heated and melted at about 1,400° C. to 1,700° C., then, the mixture is homogenized by refining, stirring, and the like, forming the glass into a sheet by a suitable method such as a float process, a down draw process, a pressing process, or the like, annealing is performed, and then the sheet is cut in a desired size.

Here, in the embodiment, the average cooling rate when annealing is performed on the formed glass is not particularly limited. However, as the average cooling rate during annealing becomes higher, it is possible to more effectively suppress the decrease ratio in the surface compressive stress of the chemically strengthened glass due to an increase of the sodium concentration in the molten salt. From the viewpoint, the average cooling rate is preferably equal to or higher than 20° C./min, more preferably equal to or higher than 30° C./min, and further preferably equal to or higher than 40° C./min.

An upper limit of the average cooling rate when annealing is performed is not particularly limited. However, as the average cooling rate during annealing becomes lower, it is possible to obtain a larger surface compressive stress when the glass is chemically strengthened. More specifically, when the average cooling rate of the glass is set to be small, a reaching fictive temperature is lowered and density of the glass is increased. Even in a case where the composition of the glass is the same, when the ion exchange is performed on a glass which is formed to be denser, an effect of increasing surface compressive stress occurring by intruded ions having a large diameter is improved. That is, as annealing (cooling) is slowly performed (as the average cooling rate becomes lower), the surface compressive stress is increased. From the viewpoint, the average cooling rate is preferably equal to or lower than 200° C./min, more preferably equal to or lower than 150° C./min, and further preferably equal to or lower than 100° C./min.

Accordingly, from a viewpoint of achieving good suppression of the decrease ratio in the surface compressive stress, which occurs by using a deteriorated salt and obtaining high surface compressive stress, the average cooling rate when annealing is performed is preferably 20° C./min to 200° C./min, more preferably 30° C./min to 150° C./min, and further preferably 40° C./min to 100° C./min.

Here, “the average cooling rate” during annealing in this description refers to an average cooling rate when annealing (cooling) is performed at a temperature (Tg+50° C.) of 50° C. higher than the glass transition temperature (Tg) to a temperature (Tg−100° C.) of 100° C. lower than the glass transition temperature (Tg) when annealing is performed on the formed glass. When a time taken to perform annealing (cooling) on the glass from (Tg+50° C.) to (Tg−100° C.) is set as t (minute), the average cooling rate can be calculated as 150/t (° C./min). This does not mean that annealing of the glass is performed only up to a temperature (Tg−100° C.) of 100° C. lower than the glass transition temperature (Tg). The glass may be subjected to annealing (cooling), for example, up to room temperature.

From a viewpoint of stress relaxation when chemical strengthening is performed, the glass transition temperature (Tg) of the glass in the embodiment is preferably equal to or higher than 550° C. and more preferably equal to or higher than 600° C. In a case where bending and forming is performed on the glass, low Tg is favorable. Tg is preferably equal to or lower than 700° C. and more preferably equal to or lower than 650° C.

In the glass in the embodiment, the temperature (T2) at which the viscosity is 10² dPa·s is preferably equal to or lower than 1,700° C., more preferably equal to or lower than 1,680° C., further preferably equal to or lower than 1,670° C., and particularly preferably equal to or lower than 1,650° C. When the temperature (T2) at which the viscosity is 10² dPa·s is equal to or lower than 1,700° C., foam quality in glass melting is good and a glass having good productivity is obtained. Thus, it is preferable.

In the glass in the embodiment, the coefficient of thermal expansion in a temperature range of 50 to 350° C. is preferably equal to or less than 100×10⁻⁷° C.⁻¹, more preferably equal to or less than 98×10⁻⁷° C.⁻¹, and further preferably equal to or less than 96×10⁻⁷° C.⁻¹. When the coefficient of thermal expansion is equal to or less than 100×10⁻⁷° C.⁻¹, a glass in which an occurrence of cracks is effectively suppressed is obtained. Thus, it is preferable. A lower limit value of the coefficient of thermal expansion in a temperature range of 50 to 350° C. is not particularly limited. The coefficient of thermal expansion is generally equal to or more than 80×10⁻⁷° C.⁻¹.

The specific gravity of the glass in the embodiment is not particularly limited. From a viewpoint of the ease of cracking occurrence, the specific gravity is preferably equal to or less than 2.49.

In a case where the glass in the embodiment has a sheet shape (glass sheet), the sheet thickness thereof is, for example, equal to or less than 2 mm, preferably equal to or less than 1.5 mm, more preferably equal to or less than 1 mm, and further preferably equal to or less than 0.8 mm. The sheet thickness is preferably equal to or more than 0.3 mm, more preferably equal to or more than 0.4 mm, and further preferably equal to or more than 0.5 mm. When the sheet thickness of a glass sheet is equal to or more than 0.3 mm, an effect of sufficiently improving strength is obtained through the chemical strengthening treatment. When the sheet thickness of the glass sheet is equal to or less than 2 mm, improvement of strength through physical strengthening is not expected, but it is possible to significantly improve strength through chemical strengthening.

The chemical strengthening treatment can be applied to the glass in the embodiment. When the glass in the embodiment is chemically strengthened, it is possible to obtain a chemically strengthened glass (in the following descriptions, also referred to as a chemically strengthened glass in the embodiment).

In the embodiment, the molten salt used in the ion exchange treatment (chemical strengthening treatment) is not particularly limited as long as the ion exchange between sodium (Na) in a surface layer of the glass and potassium (K) in the molten salt can be performed. For example, potassium nitrate (KNO₃) is exemplified.

The molten salt is required to contain K in order to perform the ion exchange. However, other restrictions are not provided as long as the molten salt does not damage the object of the embodiment. Molten potassium nitrate (KNO₃) which is described above is normally used as the molten salt. However, in addition to KNO₃, a substance which contains about 5% or less of NaNO₃ is generally used. A ratio of a K ion to a cation in the molten salt which contains K is typically equal to or more than 0.7 in molar ratio.

Regarding an ion exchange treatment condition for forming a chemically strengthened layer (compressive stress layer) having a desired surface compressive stress in a glass, if a glass sheet is provided, the ion exchange treatment condition varies depending on the thickness or the like thereof. It is typical that a glass substrate is immersed in molten KNO₃ of from 350 to 550° C. for 2 to 20 hours. From an economical viewpoint, it is preferable that the glass substrate is immersed in conditions of a temperature of from 350 to 500° C. and a period of from 2 to 16 hours. More preferably, an immersion time is from 2 to 10 hours.

In the embodiment, typically, the ion exchange treatment is repeated as follows. The ion exchange treatment in which a glass is immersed in a molten salt is performed to obtain a chemically strengthened glass, and then the chemically strengthened glass is extracted from the molten salt. Then, another glass is immersed in the same molten salt to obtain a chemically strengthened glass, and then the obtained chemically strengthened glass is extracted from the molten salt. In this manner, when the ion exchange treatment is repeated while the same molten salt is continuously used, the sodium concentration in the molten salt is increased. That is, the molten salt is deteriorated.

The glass in the embodiment has the above-described glass composition of a specific range, and, preferably, the glass is produced through annealing at the above-described average cooling rate of a specific range. Thus, even though chemical strengthening is performed through the ion exchange treatment using the deteriorated salt, it is possible to suppress the decrease ratio of the surface compressive stress and to obtain a high surface compressive stress. The decrease ratio of the surface compressive stress represents a ratio of the lowering degree of the surface compressive stress of a chemically strengthened glass which has been subjected to the ion exchange treatment by using a molten salt (deteriorated salt) in which the sodium concentration is increased, with respect to the surface compressive stress of a chemically strengthened glass which has been subjected to the ion exchange treatment by using a molten salt in which sodium is not contained or the sodium concentration is low. Here, the decrease ratio of the surface compressive stress can be evaluated based on the value of CS₂/CS₁ which is a ratio of CS₂ to CS₁.

A surface compressive stress of a chemically strengthened glass obtained in a manner that the ion exchange treatment is performed at 425° C. by using a molten salt including 100 mass % of potassium nitrate for 6 hours, with respect to a glass sheet which is formed of the glass in the embodiment and has a sheet thickness of 0.7 mm is set as CS₁. A surface compressive stress of a chemically strengthened glass obtained in a manner that the ion exchange treatment is performed at 425° C. by using a molten salt which includes 5 mass % of sodium nitrate and 95 mass % of potassium nitrate for 6 hours, with respect to the same glass sheet is set as CS₂. It can be said that as the ratio CS₂/CS₁ of CS₂ to CS₁ is increased, the decrease ratio of the surface compressive stress is decreased.

In the embodiment, CS₂/CS₁ is preferably equal to or more than 0.65, more preferably equal to or more than 0.67, further preferably equal to or more than 0.68, and particularly preferably equal to or more than 0.70. When CS₂/CS₁ is equal to or more than 0.65, the decrease ratio in the surface compressive stress, which occurs by using the deteriorated salt is sufficiently small.

The surface compressive stress of the chemically strengthened glass in the embodiment is typically equal to or more than 200 MPa. In a case of a cover glass and the like, the surface compressive stress thereof is preferably equal to or more than 500 MPa, more preferably equal to or more than 550 MPa, and particularly preferably more than 600 MPa. The surface compressive stress is typically equal to or less than 1,200 MPa.

The thickness of a compressive stress layer of the chemically strengthened glass in the embodiment is typically equal to or more than 10 μm, preferably equal to or more than 15 μm, and more preferably more than 20 μm. The thickness of the compressive stress layer is typically equal to or less than 100 μm.

The surface compressive stress of a chemically strengthened glass which is formed of the glass in the embodiment and is obtained by chemically strengthening a glass sheet which has a sheet thickness of from 0.4 to 1.0 mm is preferably equal to or more than 600 MPa, more preferably equal to or more than 700 MPa, and further preferably equal to or more than 750 MPa. The surface compressive stress of the chemically strengthened glass is typically equal to or less than 1,000 MPa. The thickness of a compressive stress layer of the chemically strengthened glass is preferably equal to or more than 20 μm, more preferably equal to or more than 25 μm, and further preferably equal to or more than 30 μm. The thickness of the compressive stress layer of the chemically strengthened glass is typically equal to or less than 80 μm.

The glass in the embodiment can be cut after the chemical strengthening treatment. As a cutting method, scribing and breaking with an ordinary wheel tip cutter can be applied, and cutting with laser is also possible. In order to maintain the glass strength, chamfering of the cut edges may be performed after cutting. The chamfering may be a mechanical grinding process, or a method of processing with a chemical of hydrofluoric acid or the like may also be employed.

The chemically strengthened glass in the embodiment can be used for a cover glass and a touch sensor glass for a touch panel display included in information equipment such as a tablet type terminal, a laptop personal computer, a smart phone, and an electronic book reader, a cover glass for electronic equipment such as a camera, a game machine, a portable music player, a cover glass for a monitor or the like of a liquid crystal television and a personal computer, a cover glass for a vehicle instrument panel, a cover glass for a solar cell, and a multiple glass used in a window of a building or a house.

The glass and the chemically strengthened glass in the embodiment typically have a sheet shape (glass sheet). However, the glass and the chemically strengthened glass may have a shape other than a sheet shape, for example, a facing shape in which the thickness of an outer periphery varies, in accordance with a product, use, and the like to be applied. The glass sheet has two main surfaces and an end surface adjacent to the main surfaces and forming the sheet thickness. The two main surfaces may form flat surfaces which are parallel to each other. The embodiment of the glass sheet is not limited thereto. For example, two main surfaces may be not parallel to each other. The entirety or a part of one or both of the two main surfaces may be a curved surface. More specifically, the glass sheet may be, for example, a flat glass sheet having no warping and or a curved glass sheet having a bent surface.

### EXAMPLES

In the following descriptions, the present invention will be described in more detail, based on examples and comparative examples.

### Experiment 1

(Producing of Glass)

Regarding Examples 1 to 19 shown in Tables 1 to 4, raw materials of each of the components were mixed so as to obtain a composition shown in columns from SiO₂ to BaO as represented by mol %, and then melted at a temperature of from 1,550 to 1,650° C. with a platinum crucible for 3 to 5 hours. When being melted, a platinum stirrer was inserted into molten glass and stirring was performed for 2 hours. Thereby, the glass was homogenized.

The obtained molten glass was cast into a mold material to form a sheet shape, and was retained at a temperature of Tg+50° C. for 1 hour. Then, it was one cooled to room temperature at a cooling rate of 0.5° C./min to obtain a glass block. The glass block was cut, polished, and finally and finally, both surfaces thereof were finished to mirror surfaces to obtain a sheet glass having a size of 2.0 mm×2.0 mm and a thickness of 0.7 mm. The obtained sheet glass was put into a mesh-belt type continuous furnace (manufactured by KOYO LINDBERG Co., Ltd.) and the temperature was increased again up to Tg+50° C. Then, cooling was performed to room temperature at a cooling rate of 40° C./min to obtain a glass sheet.

(Measurement of Glass Transition Temperature (Tg))

The glass transition temperature (Tg) of each glass was measured in a manner as follows. That is, with a silica glass as a reference sample, an extension coefficient of a glass when the glass is heated from room temperature at a rate of 5° C./min was measured to a yield point a with thermomechanical analyzer (TMA). A temperature corresponding to a bending point in a thermal expansion curve obtained was set to be the glass transition temperature. A value expressed as an italic type and having an attached underline is a value calculated from the composition of the glass. Results are shown in Tables 1 to 4.

(Measurement of Temperature (T2) at which Viscosity is 10² dPa·s)

The temperature (T2) of each glass, at which viscosity was 10² dPa·s was measured by using a rotary viscometer. A value expressed as an italic type having an attached underline is a value calculated from the composition of the glass. Results are shown in Tables 1 to 4.

(Specific Gravity)

The specific gravity of each glass was measured by the Archimedes method. A value expressed as an italic type and having an attached underline is a value calculated from the composition of the glass. Results are shown in Tables 1 to 4.

(Coefficient of Thermal Expansion)

The coefficient of thermal expansion of each glass was determined as an average linear coefficient of thermal expansion in 50 to 350° C. with a thermomechanical analyzer (TMA). A value expressed as an italic type and having an attached underline is a value calculated from the composition of the glass. Results are shown in Tables 1 to 4.

(Measurement of CS₁ and DOL₁)

The ion exchange was performed on each glass in a manner that the glass was immersed in a molten salt in which the content ratio of KNO₃ was 100 mass % and the temperature was 425° C., for 6 hours to obtain a chemically strengthened glass. A surface compressive stress CS₁ (unit: MPa) thereof and a thickness DOL₁ (unit: μm) of a compressive stress layer thereof were measured. CS₁ and DOL₁ were measured with a surface stress meter FSM-6000 manufactured by Orihara Industrial Co., Ltd. Results are shown in Tables 1 to 4.

(Measurement of CS₂)

The ion exchange was performed on each glass in a manner that the glass was immersed in a molten salt in which the content ratio of KNO₃ was 95 mass %, the content ratio of NaNO₃ was 5 mass %, and the temperature was 425° C., for 6 hours to obtain a chemically strengthened glass. A surface compressive stress CS₂ (unit: MPa) thereof was measured. CS₂ was measured by a surface stress meter FSM-6000 manufactured by Orihara Industrial Co., Ltd. Results are shown in Tables 1 to 4.

(CS₂/CS₁)

For each of the examples, CS₂/CS₁ was calculated from the measured values of CS₁ and CS₂. Results are shown in Tables 1 to 4.

Examples 1 to 15 are Examples. Examples 16 to 19 are comparative Examples.

TABLE 1

| | | Ex. 1 | Ex. 2 | Ex. 3 | Ex. 4 | Ex. 5 |
|---|---|---|---|---|---|---|
| Composition | SiO₂ | 64.6 | 64.6 | 64.6 | 64.6 | 64.0 |
| (mol %) | Al₂O₃ | 8.0 | 9.2 | 9.2 | 9.2 | 8.6 |
| | Na₂O | 15.4 | 14.2 | 13.7 | 13.7 | 15.4 |
| | K₂O | 2.1 | 2.1 | 2.6 | 2.6 | 2.1 |
| | MgO | 9.3 | 9.3 | 9.3 | 9.0 | 9.3 |
| | ZrO₂ | 0.6 | 0.6 | 0.6 | 0.9 | 0.6 |
| | B₂O₃ | 0.0 | 0.0 | 0.0 | 0.0 | 0.0 |
| | P₂O₅ | 0.0 | 0.0 | 0.0 | 0.0 | 0.0 |
| | CaO | 0.0 | 0.0 | 0.0 | 0.0 | 0.0 |
| | SrO | 0.0 | 0.0 | 0.0 | 0.0 | 0.0 |
| | BaO | 0.0 | 0.0 | 0.0 | 0.0 | 0.0 |

| | | | | | |
|---|---|---|---|---|---|
| 2 × Al₂O₃/SiO₂ | 0.25 | 0.28 | 0.28 | 0.28 | 0.27 |
| K₂O/Na₂O | 0.14 | 0.15 | 0.19 | 0.19 | 0.14 |
| Tg (° C.) | 604 | 629 | 628 | 638 | 608 |
| T2 (° C.) | 1,590 | 1,634 | 1,636 | 1,637 | 1,597 |
| Specific gravity | 2.479 | 2.477 | 2.476 | 2.483 | 2.482 |
| Coefficient of thermal | 97 | 93 | 94 | 92 | 98 |
| expansion (×10⁻⁷° C.⁻¹) | | | | | |
| CS₁ (MPa) | 950 | 1,047 | 1,021 | 1,046 | 995 |
| DOL₁ (μm) | 45.4 | 43.1 | 46.0 | 45.6 | 45.4 |
| CS₂ (MPa) | 681 | 722 | 694 | 702 | 704 |
| CS₂/CS₁ | 0.72 | 0.69 | 0.68 | 0.67 | 0.71 |

TABLE 2

| | | Ex. 6 | Ex. 7 | Ex. 8 | Ex. 9 | Ex. 10 |
|---|---|---|---|---|---|---|
| Composition | SiO₂ | 64.0 | 64.8 | 64.3 | 64.3 | 64.3 |
| (mol %) | Al₂O₃ | 8.6 | 9.1 | 8.8 | 8.8 | 8.8 |
| | Na₂O | 12.9 | 12.9 | 15.2 | 16.0 | 15.2 |
| | K₂O | 3.6 | 3.1 | 2.7 | 1.9 | 2.7 |
| | MgO | 10.3 | 9.5 | 8.2 | 8.2 | 8.1 |
| | ZrO₂ | 0.6 | 0.6 | 0.8 | 0.8 | 0.8 |
| | B₂O₃ | 0.0 | 0.0 | 0.0 | 0.0 | 0.0 |
| | P₂O₅ | 0.0 | 0.0 | 0.0 | 0.0 | 0.0 |
| | CaO | 0.0 | 0.0 | 0.0 | 0.0 | 0.1 |
| | SrO | 0.0 | 0.0 | 0.0 | 0.0 | 0.0 |
| | BaO | 0.0 | 0.0 | 0.0 | 0.0 | 0.0 |

| | | | | | |
|---|---|---|---|---|---|
| 2 × Al₂O₃/SiO₂ | 0.27 | 0.28 | 0.27 | 0.27 | 0.27 |
| K₂O/Na₂O | 0.28 | 0.24 | 0.18 | 0.12 | 0.18 |
| Tg (° C.) | 623 | 635 | 607 | 607 | 606 |
| T2 (° C.) | 1,615 | 1,645 | 1,618 | 1,605 | 1,619 |
| Specific gravity | 2.481 | 2.475 | 2.484 | 2.484 | 2.485 |
| Coefficient of thermal | 96 | 92 | 100 | 98 | 100 |
| expansion (×10⁻⁷° C.⁻¹) | | | | | |
| CS₁ (MPa) | 960 | 987 | 970 | 995 | 977 |
| DOL₁ (μm) | 50.6 | 50.1 | 51.4 | 48.3 | 49.0 |
| CS₂ (MPa) | 621 | 659 | 679 | 719 | 677 |
| CS₂/CS₁ | 0.65 | 0.67 | 0.70 | 0.72 | 0.69 |

TABLE 3

| | | Ex. 11 | Ex. 12 | Ex. 13 | Ex. 14 | Ex. 15 |
|---|---|---|---|---|---|---|
| Composition | SiO₂ | 66.6 | 64.6 | 62.6 | 64.6 | 64.3 |
| (mol %) | Al₂O₃ | 8.0 | 10.0 | 12.0 | 8.0 | 9.2 |
| | Na₂O | 12.5 | 12.5 | 12.5 | 16.5 | 15.5 |
| | K₂O | 2.0 | 2.0 | 2.0 | 2.0 | 2.0 |
| | MgO | 10.4 | 10.4 | 10.4 | 8.4 | 7.0 |
| | ZrO₂ | 0.5 | 0.5 | 0.5 | 0.5 | 2.0 |
| | B₂O₃ | 0.0 | 0.0 | 0.0 | 0.0 | 0.0 |
| | P₂O₅ | 0.0 | 0.0 | 0.0 | 0.0 | 0.0 |
| | CaO | 0.0 | 0.0 | 0.0 | 0.0 | 0.0 |
| | SrO | 0.0 | 0.0 | 0.0 | 0.0 | 0.0 |
| | BaO | 0.0 | 0.0 | 0.0 | 0.0 | 0.0 |

| | | | | | |
|---|---|---|---|---|---|
| 2 × Al₂O₃/SiO₂ | 0.24 | 0.31 | 0.38 | 0.25 | 0.29 |
| K₂O/Na₂O | 0.16 | 0.16 | 0.16 | 0.12 | 0.13 |
| Tg (° C.) | 637 | 658 | 678 | 588 | 630 |
| T2 (° C.) | 1,652 | 1,655 | 1,654 | 1,603 | 1,613 |
| Specific gravity | 2.460 | 2.470 | 2.485 | 2.475 | 2.511 |
| Coefficient of thermal | 86 | 85 | 84 | 102 | 94 |
| expansion (×10⁻⁷° C.⁻¹) | | | | | |
| CS₁ (MPa) | 972 | 1,069 | 1,131 | 860 | 1,151 |
| DOL₁ (μm) | 39.6 | 38.2 | 37.1 | 47.6 | 43.3 |
| CS₂ (MPa) | 679 | 711 | 731 | 643 | 780 |
| CS₂/CS₁ | 0.70 | 0.67 | 0.65 | 0.75 | 0.68 |

TABLE 4

| | | Ex. 16 | Ex. 17 | Ex. 18 | Ex. 19 |
|---|---|---|---|---|---|
| Composition | SiO₂ | 64.3 | 68.6 | 68.6 | 58.3 |
| (mol %) | Al₂O₃ | 8.0 | 8.0 | 10.0 | 14.0 |
| | Na₂O | 12.7 | 12.5 | 12.5 | 13.2 |
| | K₂O | 4.0 | 0.0 | 2.0 | 4.0 |
| | MgO | 10.4 | 10.4 | 6.4 | 8.0 |
| | ZrO₂ | 0.5 | 0.5 | 0.5 | 2.5 |
| | B₂O₃ | 0.0 | 0.0 | 0.0 | 0.0 |
| | P₂O₅ | 0.0 | 0.0 | 0.0 | 0.0 |
| | CaO | 0.1 | 0.0 | 0.0 | 0.0 |
| | SrO | 0.0 | 0.0 | 0.0 | 0.0 |
| | BaO | 0.0 | 0.0 | 0.0 | 0.0 |

| | | | | |
|---|---|---|---|---|
| 2 × Al₂O₃/SiO₂ | 0.25 | 0.23 | 0.29 | 0.48 |
| K₂O/Na₂O | 0.31 | 0.00 | 0.16 | 0.30 |
| Tg (° C.) | 608 | 661 | 657 | 691 |
| T2 (° C.) | 1,601 | 1,689 | 1,751 | 1,625 |
| Specific gravity | 2.479 | 2.444 | 2.443 | 2.548 |
| Coefficient of thermal | 98 | 74 | 88 | 93 |
| expansion | | | | |
| (×10⁻⁷° C.⁻¹) | | | | |
| CS₁ (MPa) | 884 | 1,044 | 992 | 1,230 |
| DOL₁ (μm) | 51.5 | 26.1 | 53.0 | 47.6 |
| CS₂ (MPa) | 584 | 760 | 714 | 697 |
| CS₂/CS₁ | 0.66 | 0.73 | 0.72 | 0.57 |

All of the chemically strengthened glasses in Examples 1 to 15 had high CS₂/CS₁ which was equal to or more than 0.65, and the decrease ratio in the surface compressive stress, which occurred by using a deteriorated salt was sufficiently small. Further, for example, a chemically strengthened glass used for a cover glass for mobile equipment is generally required that a surface compressive stress thereof is equal to or more than 600 MPa. All of the glasses in Examples 1 to 15 had CS₂ which was equal to or more than 600 MPa. Therefore, these satisfied the requirement. Further, in all of the chemically strengthened glasses in Examples 1 to 15, the temperature (T2) at which the viscosity was 10² dPa·s was sufficiently low. In addition, foam quality in glass melting was also excellent, and productivity was good.

The glass in Example 16 has high K₂O/Na₂O, which is 0.31. As a result, in the chemically strengthened glass in Example 16, CS₂ thereof was less than 600 MPa. Therefore, the requirement was not satisfied.

The glass in Example 17 does not contain K₂O, and has K₂O/Na₂O of 0. As a result, in the chemically strengthened glass in Example 17, DOL₁ thereof was 26.1 μm and was smaller than DOL₁ of the chemically strengthened glasses in Examples 1 to 15. Application of chemical strengthening was difficult and productivity was degraded.

The glass in Example 18 has the high content of SiO₂, which is 68.6%. As a result, although chemical strengthening characteristics of the chemically strengthened glass in Example 18 were good, the glass in Example 18 had the high temperature (T2) of 1,751° C., at which the viscosity was 10² dPa·s. Further, foam quality in glass melting was bad and productivity was degraded.

The glass in Example 19 has high 2×Al₂O₃/SiO₂, which is 0.48. As a result, the chemically strengthened glass in Example 19 had CS₂/CS₁ which was 0.57 and low, and had a high decrease ratio in the surface compressive stress, which occurs by using a deteriorated salt.

### Experiment 2

A chemically strengthened glass was produced in a manner similar to the producing procedures of the chemically strengthened glass in Example 9 except that the average cooling rate of the glass during annealing was changed to 0.1° C./min, 1° C./min, 23° C./min, 51° C./min, or 350° C./min. A chemically strengthened glass was produced in a manner similar to the producing procedures of the chemically strengthened glass in Example 16 except that the average cooling rate of the glass during annealing was changed to 0.1° C./min, 1° C./min, 23° C./min, 51° C./min, or 350° C./min.

For each of the produced glasses, CS₁, DOL_{T}, CS₂, and CS₂/CS₁ were measured or calculated in a manner similar to that in Experiment 1. Results are shown in Table 5.

A definition method of the reaching fictive temperature of each glass will be described. When the heat treatment is performed at a certain temperature until the glass is in a thermodynamically equilibrium state and the glass is quenched to room temperature at a cooling rate of 10,000° C./min or more, a glass frozen with a structure at the heat treatment temperature is obtained. The heat treatment temperature at this time is defined as the fictive temperature of the glass. A refraction index of the glass obtained by quenching was measured and a calibration curve of the fictive temperature and the refraction index was made. Here, in Example 9, heat treatment was performed at each heat treatment temperature of 580° C., 600° C., 610° C., 625° C., and 635° C. In Example 16, heat treatment was performed at each heat treatment temperature of 570° C., 590° C., 600° C., 615° C., and 625° C. Then the calibration curves were made. The refraction index of a sample which had been cooled at the average cooling rate shown in Table 5 was measured and the reaching fictive temperature was defined by using the calibration curve which had been made in advance. Results are shown in Table 5.

TABLE 5

| | | Average | Reaching | | | | |
|---|---|---|---|---|---|---|---|
| | | cooling | fictive | | | | |
| Glass | | rate | temper- | | | | |
| mate- | Tg | (° C./ | ature | CS₁ | DOL₁ | CS₂ | CS₁/ |
| rial | (° C.) | min) | (° C.) | (MPa) | (μm) | (MPa) | CS₂ |
| Ex. 9 | 607 | 0.1 | 551.1 | 1,157 | 35.9 | 764 | 0.660 |
| | | 1 | 573.9 | 1,081 | 40.2 | 754 | 0.697 |
| | | 23 | 604.0 | 1,047 | 43.9 | 738 | 0.705 |
| | | 51 | 612.6 | 990 | 45.1 | 715 | 0.722 |
| | | 350 | 631.2 | 945 | 48.0 | 685 | 0.725 |
| Ex. 16 | 608 | 0.1 | 547.9 | 972 | — | 604 | 0.621 |
| | | 1 | 564.3 | 959 | 43.3 | 595 | 0.621 |
| | | 23 | 605.7 | 949 | 47.7 | 595 | 0.627 |
| | | 51 | 614.5 | 908 | 49.9 | 582 | 0.641 |
| | | 350 | 635.2 | 878 | 52.0 | 567 | 0.646 |

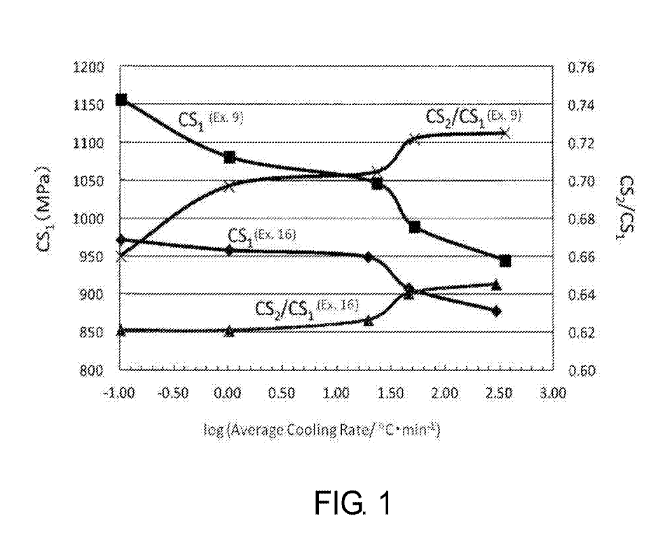

FIG. 1 shows a semilogarithmic graph which indicates a relationship between the logarithm (horizontal axis) of the average cooling rate, and CS₁ and CS₂/CS₁ (vertical axis) for glasses in Example 9 and Example 16.

As shown in Table 5 and FIG. 1, it is understood that the value of CS₂/CS₁ is increased as the average cooling rate becomes higher in the glass in Example 9. As shown in Table 5, it is understood that the reaching fictive temperature is increased as the average cooling rate becomes higher. In particular, the followings are understood. The glass transition temperature (607° C.) in Example 9 is between the reaching fictive temperature (604.0° C.) in a case where the average cooling rate is 23° C./min and the reaching fictive temperature (612.6° C.) in a case where the average cooling rate is 51° C./min. It is understood that as illustrated in FIG. 1, the value of CS₂/CS₁ is rapidly increased in a range of the average cooling rate of from 23° C. to 51° C. Although the value of CS₂/CS₁ is gradually increased in a range of the average cooling rate of more than 51° C./min, the width of an increase is narrow in a range of the average cooling rate of more than 200° C./min or so.

On the other hand, as shown in Table 5 and FIG. 1, it is understood that the value of CS₁ is decreased as the average cooling rate becomes higher in the glass in Example 9. In particular, the glass transition temperature (607° C.) in Example 9 is between the reaching fictive temperature (604.0° C.) in a case where the average cooling rate is 23° C./min and the reaching fictive temperature (612.6° C.) in a case where the average cooling rate is 51° C./min. It is understood that as illustrated in FIG. 1, the value of CS₁ is rapidly decreased in the range of the average cooling rate of from 23° C. to 51° C. It is understood that the value of CS₁ is gradually decreased also in a range of the average cooling rate of more than 51° C./min.

It is understood that the glass in Example 16 has the similar tendency.

Accordingly, considering that a range where the value of CS₂/CS₁ is high and the value of CS₁ is high is preferable, it is understood that the average cooling rate is preferably from 20° C./min to 200° C./min or so.

The present invention is described in detail with reference to the specific embodiment. However, various changes and modifications may be made without departing from the gist and the scope of the present invention, and this is obvious from the person skilled in the related art.

This application is based upon and claims the benefit of priority from Japanese Patent Application No. 2014-266098 filed on Dec. 26, 2014. The contents of those applications are incorporated herein by reference in their entireties.

1. A glass comprising, as represented by mole percentage based on oxides, from 60 to 68% of SiO₂, from 8 to 12% of Al₂O₃, from 12 to 20% of Na₂O, from 0.1 to 6% of K₂O, from 6.4 to 12.5% of MgO, and from 0.001 to 4% of ZrO₂, wherein a total content of B₂O₃, P₂O₅, CaO, SrO, and BaO is from 0 to 1%, and the glass satisfying 2×Al₂O₃/SiO₂≦0.4 and 0<K₂O/Na₂O≦0.3.

2. The glass according to claim 1, wherein Li₂O is substantially not contained.

3. The glass according to claim 1, wherein a total content of B₂O₃ and P₂O₅ is equal to or less than 0.2%.

4. The glass according to claim 1, wherein a total content of SiO₂, Al₂O₃, MgO, CaO, ZrO₂, Na₂O, and K₂O is equal to or more than 98.5%.

5. The glass according to claim 1, wherein SnO₂ is substantially not contained.

6. The glass according to claim 1, wherein Sb₂Os₃ and As₂O₃ are substantially not contained.

7. The glass according to claim 1, wherein the glass is produced through annealing in which an average cooling rate is from 20° C./min to 200° C./min.

8. The glass according to claim 1, wherein a temperature (T2) at which a viscosity is 10² dPa·s is equal to or lower than 1,700° C.

9. The glass according to claim 1, wherein a coefficient of thermal expansion in a temperature range of from 50 to 350° C. is equal to or less than 100×10⁻⁷° C.⁻¹.

10. The glass according to claim 1, wherein the glass is a glass sheet having a sheet thickness of 1.5 mm or less.

11. The glass according to claim 1, wherein when a surface compressive stress of a chemically strengthened glass obtained by performing an ion exchange treatment on a glass sheet having a sheet thickness of 0.7 mm at 425° C. for 6 hours using a molten salt which includes 100 mass % of potassium nitrate is set as CS₁, and a surface compressive stress of a chemically strengthened glass obtained by performing an ion exchange treatment on a glass sheet having a sheet thickness of 0.7 mm at 425° C. for 6 hours using a molten salt which includes 5 mass % of sodium nitrate and 95 mass % of potassium nitrate is set as CS₂, a ratio CS₂/CS₁ of CS₂ to CS₁ is equal to or more than 0.65.

12. The glass according to claim 1, to which a chemical strengthening treatment is applicable.

13. A chemically strengthened glass which is obtained by chemically strengthening the glass according to claim 12.

14. The chemically strengthened glass according to claim 13, wherein a thickness of a compressive stress layer formed in a surface of the chemically strengthened glass is equal to or more than 10 and a surface compressive stress is equal to or more than 200 MPa.
